(19) United States
(12) Patent Application Publication
(10) Pub. No.: US 2021/0210909 A1
(43) Pub. Date: Jul. 8, 2021

(54) CIRCUIT BOARD SHIELD CONNECTOR

(71) Applicant: YAZAKI CORPORATION, Tokyo (JP)

(72) Inventors: Yoshimi Wada, Shizuoka (JP); Takayuki Kobayashi, Shizuoka (JP)

(73) Assignee: YAZAKI CORPORATION, Tokyo (JP)

(21) Appl. No.: 17/140,571

(22) Filed: Jan. 4, 2021

(30) Foreign Application Priority Data
Jan. 6, 2020 (JP) 2020-000274

(51) Int. Cl. H01R 13/6594; H01R 12/71

(52) U.S. Cl. CPC H01R 13/6594; H01R 12/716

(57) ABSTRACT

A shield connector is provided with an inner terminal having a connection part configured to connect electrically to a mating terminal and an outer terminal having a cylindrical part configured to form a shield circuit with a mating shield member. The inner terminal includes an inner connection part configured to connect electrically to a circuit board. The outer terminal includes a plurality of outer connection parts extending from the cylindrical part and configured to be grounded to the circuit board. With respect to the inner connection part, a first outer connection part is on a front side of the other outer connection part of the plurality of outer connection parts in a fitting direction of the connection part. A space between the inner connection part and the first outer connection part is set wider than a space between the inner connection part and the other outer connection part.

### CROSS REFERENCE TO RELATED APPLICATION

The present application is based on, and claims priority from Japanese Patent Application No. 2020-000274, filed on Jan. 6, 2020, the entire contents of which are incorporated herein by reference.

### TECHNICAL FIELD

The present disclosure relates to a circuit board shield connector.

### RELATED ART

Conventionally, a circuit board shield connector having an inner conductor terminal as an inner terminal electrically connected to the circuit board and an outer conductor terminal as an outer terminal grounded to the circuit board is known (See JP 2013-48048 A). The inner conductor terminal has a connection part in which a mating terminal is fitted along a planar direction of the circuit board and electrically connected to the mating terminal. Further, the outer conductor terminal has a cylindrical part which is formed in a cylindrical shape and which extends along the planar direction of the circuit board and covers the outer periphery of the connection part while being separated from the connection part, and configured to contact with a mating shield member to form a shield circuit.

In the circuit board shield connector, an inner conductor lead part as an inner connection part extended from the connection part toward the circuit board side and electrically connected to the circuit board is provided on the inner conductor terminal. Further, the outer conductor terminal is provided with a plurality of outer conductor leads serving as outer connection parts extending from the cylindrical part toward the circuit board side and grounded to the circuit board.

In such a shield connector, the inner conductor terminal is electrically connected to the mating terminal by being fitted to a mating connector. The outer conductor terminal is in contact with the mating shield member to form the shield circuit.

By forming the shield circuit in this manner, the conduction noise transmitted to the outer conductor terminal can be removed to the circuit board (ground pattern), and the noise can be prevented from entering the inner conductor terminal.

### SUMMARY

In the circuit board shield connector as described above, the conduction noise transmitted from the mating shield member to the outer terminal is grounded via the outer connection part to the circuit board. At this time, if the inner connection part is close to the outer connection part on the circuit board, the conduction noise that flow through the outer connection part may affect the inner connection part. When the inner connection part is affected by the conduction noise, an electric signal transmitted through the inner terminal may be disturbed, and there is a possibility that a device or the like electrically connected to the circuit board may malfunction.

An object of the present disclosure is to provide a shielded connector for a circuit board that can suppress an influence of conduction noise that flow through an outer terminal on an inner terminal.

A circuit board shield connector according to an embodiment includes an inner terminal having a connection part configured to connect electrically to a circuit board and to connect electrically to a mating terminal by fitting the mating terminal along a planar direction of the circuit board, and an outer terminal having a cylindrical part, the cylindrical part formed in a cylindrical shape and configured to extend along the planar direction of the circuit board and covering the outer periphery of the connection part while being separated from the connection part and configured to contact with a mating shield member to form a shield circuit, and configured to be grounded to the circuit board. The inner terminal includes an inner connection part, the inner connection part extending from the connection part toward the circuit board side and configured to connect electrically to the circuit board. The outer terminal includes a plurality of outer connection parts, the plurality of outer connection parts extending from the cylindrical part toward the circuit board side and configured to be grounded to the circuit board. With respect to the inner connection part, at least one first outer connection part included in the plurality of outer connection parts is at a front side of the other outer connection part of the plurality of outer connection parts in a fitting direction of the connection part. On the circuit board, a space between the inner connection part and the first outer connection part is set wider than a space between the inner connection part and the other outer connection part.

The cylindrical part and the first outer connection part may be formed as separate bodies.

According to the above configuration, it is possible to provide a circuit board shield connector that can suppress an influence of conduction noise that flow through an outer terminal on an inner terminal.

### BRIEF DESCRIPTION OF THE DRAWINGS

FIG. 1 is a perspective view of a circuit board shield connector according to a first embodiment;

FIG. 2 is an exploded perspective view of the circuit board shield connector according to the first embodiment;

FIG. 3 is a perspective view of the circuit board shield connector according to the first embodiment, in which a shield member and an outer housing in FIG. 1 are omitted;

FIG. 4 is an enlarged view of a major portion of FIG. 3;

FIG. 5 is a cross-sectional view of FIG. 3;

FIG. 6 is a perspective view of a circuit board shield connector according to a second embodiment, in which a shield member and an outer housing in FIG. 1 are omitted;

FIG. 7 is an enlarged view of a major portion of FIG. 6; and

FIG. 8 is a side view of FIG. 6.

### DETAILED DESCRIPTION

Various embodiments will be described hereinafter with reference to the accompanying drawings.

### First Embodiment

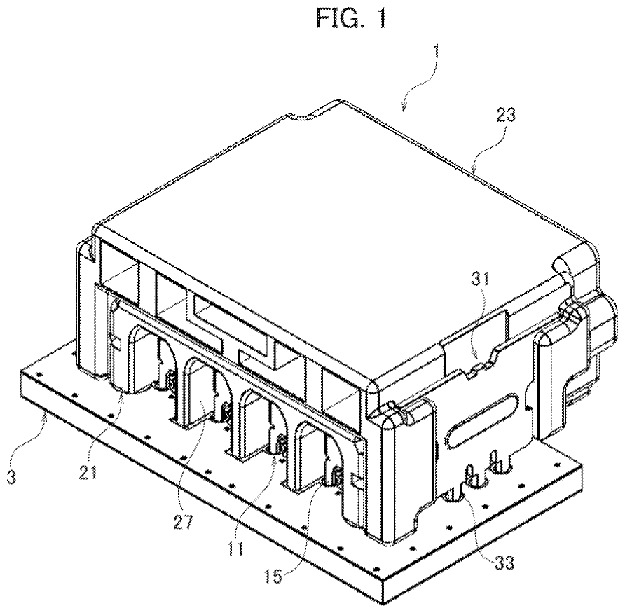

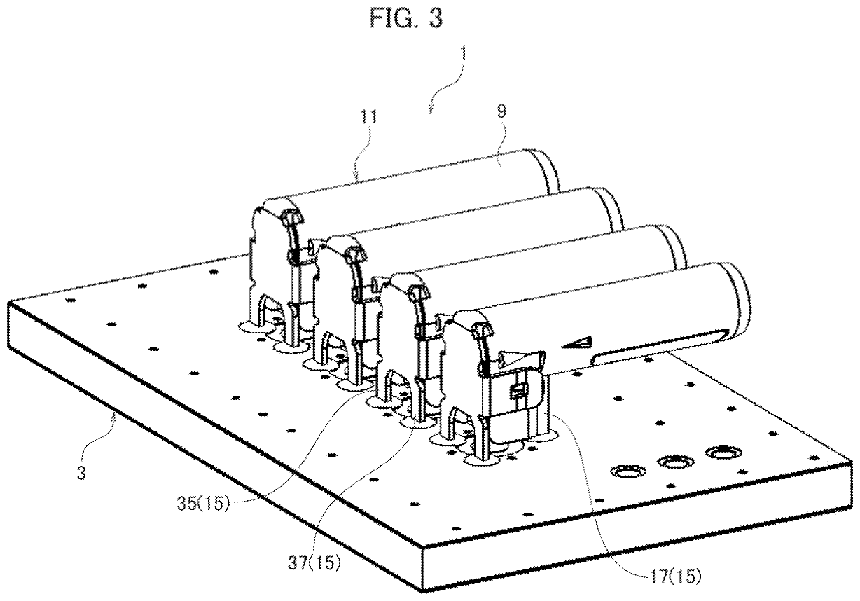

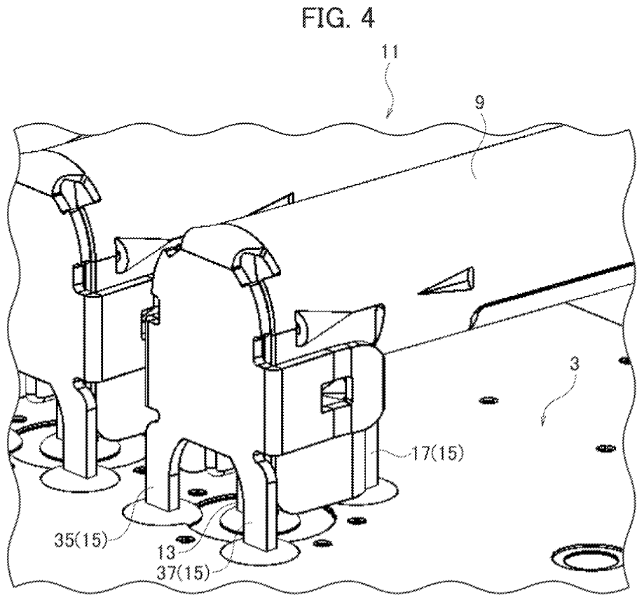

A first embodiment will be described with reference to FIGS. 1 to 5. In FIGS. 3 to 5, a shield member 21 and an outer housing 23 are not illustrated.

A circuit board shield connector 1 according to the present embodiment includes an inner terminal 7 configured to connect electrically to a circuit board 3 and an outer terminal 11 grounded to the circuit board 3. The inner terminal 7 has a connection part 5 configured to connect electrically to a mating terminal (not illustrated) when the mating terminal is fitted along a planar direction of the circuit board 3. The outer terminal 11 has a cylindrical part 9 formed in a cylindrical shape. The outer terminal 11 extends along the planar direction of the circuit beard 3 and covers the outer periphery of the connection part 5 while being separated from the connection part 5. The outer terminal 11 is configured to be grounded to the circuit board 3 and the cylindrical part 9 is configured to be in contact with a mating shield member (not illustrated) so as to form a shield circuit.

The inner terminal 7 includes an inner connection part 13. The inner connection part 13 extends from the connection part 5 toward the circuit board 3 side and is configured to connect electrically to the circuit board 3. The outer terminal 11 includes a plurality of outer connection parts 15. The plurality of outer connection parts 15 extends from the cylindrical part 9 toward the circuit board 3 side and is configured to be grounded to the circuit board 3.

With respect to the inner connection part 13, at least one first outer connection part 17 included in the plurality of outer connection parts 15 is at a front side of the other outer connection parts 35, 37 of the plurality of outer connection parts 15 in the fitting direction of the connection part 5. On the circuit board 3, a space L1 between the inner connection part 13 and the first outer connection part 17 is set wider than a space L2 between the inner connection part 13 and the other outer connection parts 35, 37.

As illustrated in FIGS. 1 to 5, the circuit board shield connector 1 is configured to connect electrically to a device or the like. The circuit board shield connector 1 is configured to mount on the circuit board 3 as a circuit board on which electronic components (not illustrated) for controlling an operation of the device are mounted. The circuit board shield connector 1 is configured so as a mating connector (not illustrated) to be fitted to the circuit board shield connector 1. The mating connector may be a connector electrically connected to a controller (not illustrated) for controlling the operation of equipment, for example. In the above configuration, an electric signal from the controller is input to the circuit board 3. The circuit board shield connector 1 includes an inner terminal 7, an inner housing 19, an outer terminal 11, a shield member 21, and an outer housing 23.

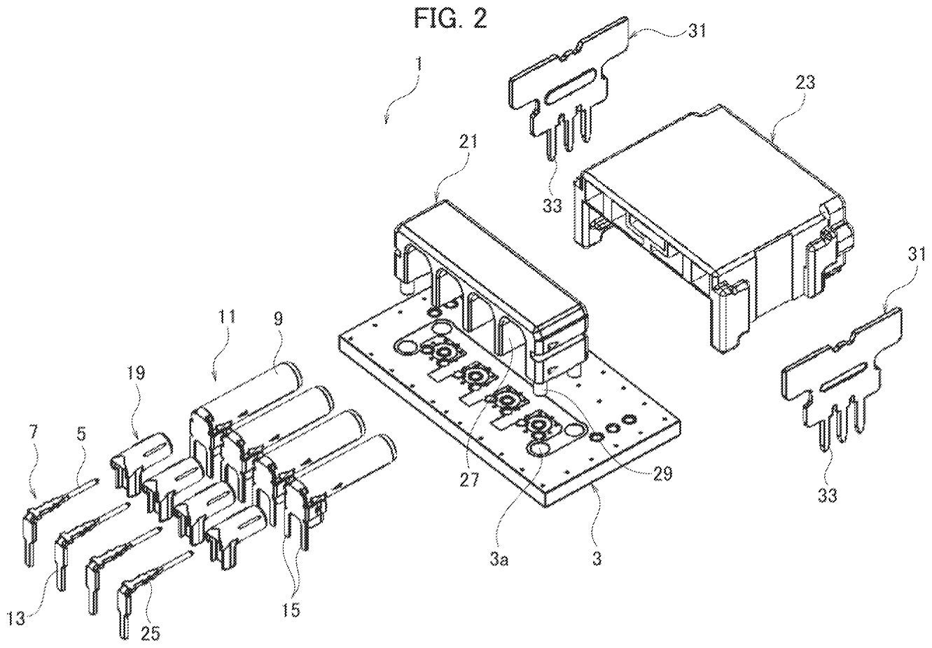

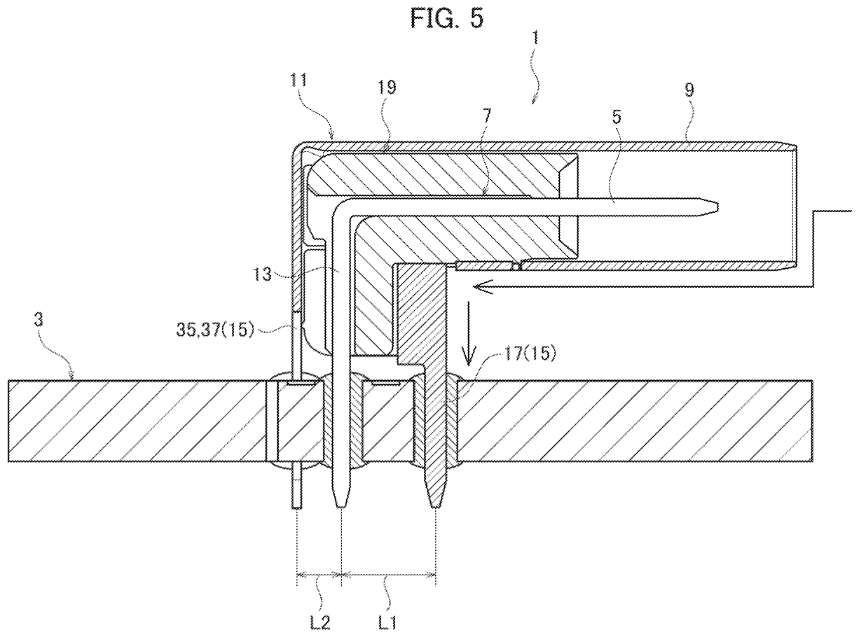

The inner terminal 7 is made of a conductive material. As illustrated in FIGS. 2 and 5, the inner terminal 7 includes a connection part 5, an inner connection part 13, and press-fit parts 25.

The connection part 5 is formed in a rod shape and extended along the planar direction of the circuit board 3. In a state that the mating connector is fitted to the circuit board shield connector 1, the connection part 5 is configured to fit to a mating terminal (not illustrated) having a box-shaped connection part accommodated in the mating connector. The connection part 5 is fitted to the mating terminal along the planar direction of the circuit board 3. The inner terminal 7 and the mating terminal are electrically connected by fitting the connection part 5 into the mating terminal.

The inner connection part 13 is formed of a single member being continuous with the connection part 5. The inner connection part 13 is extended in a direction orthogonal to the fitting direction of the connection part 5 by bending one end of the connection part 5 toward the circuit board 3 side. The inner connection part 13 is electrically connected to a conductive pattern formed on the circuit board 3 by soldering. Accordingly, the inner terminal 7 is electrically connected to the circuit board 3.

The press-fit parts 25 are formed of a single member being continuous with the connection part 5 on the inner connection part 13 side of the connection part 5. The press-fit parts 25 are provided in a protruding manner on both sides of the connection part 5 in the width direction along a longitudinal direction of the connection part 5. The press-fit parts 25 are press-fitted into an inner wall surface of the inner housing 19. Accordingly, the inner terminal 7 is fixed to the inner housing 19.

The inner housing 19 is made of an insulating material such as synthetic resin. As illustrated in FIGS. 2 and 5, a plurality of the inner housings 19 are mounted on the circuit board 3 so as each of a plurality of inner terminals 7 is capable of being accommodated in each inner housing 19. The inner housing 19 is formed in a cylindrical shape and configured to accommodate the connection part 5 of the inner terminal 7. In such an inner housing 19, the press-fit part 25 of the inner terminal 7 is press-fitted into the inner wall surface of the inner housing 19, and the inner terminal 7 is fixed to the inner housing 19 so as to accommodate the connection portion 5 of the inner terminal 7. The inner housing 19 is accommodated in the outer terminal 11. At this time, the inner housing 19 retains insulation between the inner terminal 7 and the outer terminal 11.

The outer terminal 11 is made of a conductive material. As illustrated in FIGS. 2 to 5, each of a plurality of the outer terminals 11 accommodates each of the plurality of inner housings 19. The outer terminal 11 includes a cylindrical part 9 and a plurality of outer connection parts 15.

The cylindrical part 9 is formed in a cylindrical shape and extends along the planar direction of the circuit board 3 so as to accommodate the inner housing 19. In a state where the circuit board shield connector 1 and the mating connector are fitted to each other, the cylindrical part 9 is brought into contact with a mating shield member (not illustrated) housed in the mating connector in a state and form a shield circuit with the mating shield member. By forming the shield circuit, entering of noise to the inner terminal 7 from the outside or leakage of noise from the inner terminal 7 can be prevented.

Each of the plurality of outer connection parts 15 is formed of a single member being continuous with the cylindrical part 9. Each outer connection part 15 extends from the cylindrical portion 9 toward the circuit board 3 side in a direction orthogonal to the fitting direction of the circuit board shield connector 1 and the mating connector. The plurality of outer connection parts 15 is electrically connected to a ground pattern formed on the circuit board 3 by soldering. Accordingly, the outer terminal 11 is grounded to the circuit board 3. The outer terminal 11 is accommodated in the shield member 21 and the outer housing 23.

The shield member 21 is made of a conductive material formed by die casting. As illustrated in FIGS. 1 and 2, the shield member 21 is provided with a plurality of accommodating recesses 27 formed to accommodate each of a plurality of outer terminals 11 to respective accommodating recesses 27. The inner peripheral surface of the plurality of accommodating recesses 27 is in contact with the outer peripheral surface of the outer terminal 11 and the outer terminal 11 and the shield member 21 are electrically connected to each other. The shield member 21 has a plurality of protrusions 29. The shield member 21 is grounded to the circuit board 3 by inserting the plurality of protrusions 29 into holes 3a formed in the circuit board 3 and electrically connecting the plurality of protrusions 29 to the ground pattern by soldering. The shield member 21 is accommodated in the outer housing 23.

The outer housing 23 is made of an insulating material such as synthetic resin. As illustrated in FIGS. 1 and 2, the outer housing 23 is formed in a frame shape and is configured to accommodate the shield member 21 and the outer terminal 21 accommodated in the shield member 21. On both sides of the outer housing 23, metal pegs 31 are fixed by fixing means such as press-fitting. The pegs 31 are provided with a plurality of fixing parts 33 configured to be fixed to the circuit board 3 by soldering. The outer housing 23 is configured to be fixed onto the circuit board 3 through the pegs 31. A mating connector is fitted to the outer housing 23 along the planar direction of the circuit board 3.

In the circuit board shield connector 1, while the mating connector is fitted, the inner terminal 7 is electrically connected to the mating terminal. Thus, an electric signal from the controller can be inputted to the circuit board 3. At this time, the outer terminal 11 is electrically connected to the mating shield member and forms a shield circuit. Thus, the inner terminal 7 is protected from external noise.

In such a circuit board shielded connector 1, conduction noise may be transmitted from the mating shield member to the outer terminal 11 while the mating connector is fitted to the circuit board shield connector 1. At this time, the conduction noise transmits through the cylindrical part 9 of the outer terminal 11 and is grounded to the circuit board 3 via the plurality of outer connection parts 15 of the outer terminal 11. When the conduction noise flows on the circuit board 3 in the vicinity of the inner connection part 13 of the inner terminal 7, the electric signal may be disturbed, and the device or the like electrically connected to the circuit board 3 may malfunction.

Therefore, in the circuit board shielded connector 1, at least one of the plurality of outer connection parts 15, the first outer connection part 17, is disposed in front of the inner connection part 13 in the fitting direction of the connection part 5 with respect, to the other outer connection parts 35, 37. On the circuit board 3, a space L1 between the inner connection part 13 and the first outer connection part 17 in the fitting direction of the connection part 5 is set wider than a space L2 between the inner connection part 13 and the other outer connection parts 35, 37.

As illustrated in FIGS. 3 to 5, the plurality of outer connection parts 15 include the first outer connection part 17, a second outer connection part 35, and a third outer connection part 37. The first outer connection part 17 is arranged at the front side in the fitting direction between the connection part 5 and the mating terminal of the second outer connection part 35 and the third outer connection part 37 with respect to the inner connection part 13. Therefore, as indicated by an arrow illustrated in FIG. 5, the conduction noise transmitted from the mating shield member to the cylindrical part 9 flows from the first outer connection part 17 to the circuit board 3 prior to the second outer connection part 35 and the third outer connection part 37.

The space L1 between the first outer connection part 17 through which conduction noise flows first and the inner connection part 13 is set wider than the space L2 between the second outer connection part 35 or the third outer connection part 37 and the inner connection part 13. Therefore, on the circuit board 3, the conduction noise that flow through the first outer connection part 17 before flowing through the second outer connection part 35 or the third outer connection part 37 does not flow near the inner connection part 13. Therefore, on the circuit board 3, the conduction noise that flow near the inner connection part 13 can be reduced, and the influence of the conduction noise to the electric signal flowing through the inner connection part 13 can be suppressed. Therefore, the disturbance of the electric signal is reduced, and the stable electric signal can be input to the circuit board 3 electrically connected to the device or the like.

In such a circuit board shielded connector 1, the first outer connection part 17 is arranged at the front side in the fitting direction of the connection part 5 of the other outer connection parts 35, 37 with respect to the inner connection part 13. Therefore, the conduction noise transmitted from the mating shield member can be made to flow to the circuit board 3 from the first outer connection part 17 prior to the other outer connection parts 35, 37.

On the circuit board 3, the space L1 between the inner connection part 13 and the first outer connection part 17 is set wider than the space L2 between the inner connection part 13 and the ether outer connection parts 35, 37. Therefore, on the circuit board 3, the conduction noise that flow through the first outer connection part 17 prior to the other outer connection parts 35, 37 does not flow near the inner connection part 13.

Therefore, in the circuit board shield connector 1, the conduction noise that flow near the inner connection part 13 can be reduced, and the influence to the inner terminal 7 by the conduction noise that flow through the outer terminal 11 can be effectively suppressed.

### Second Embodiment

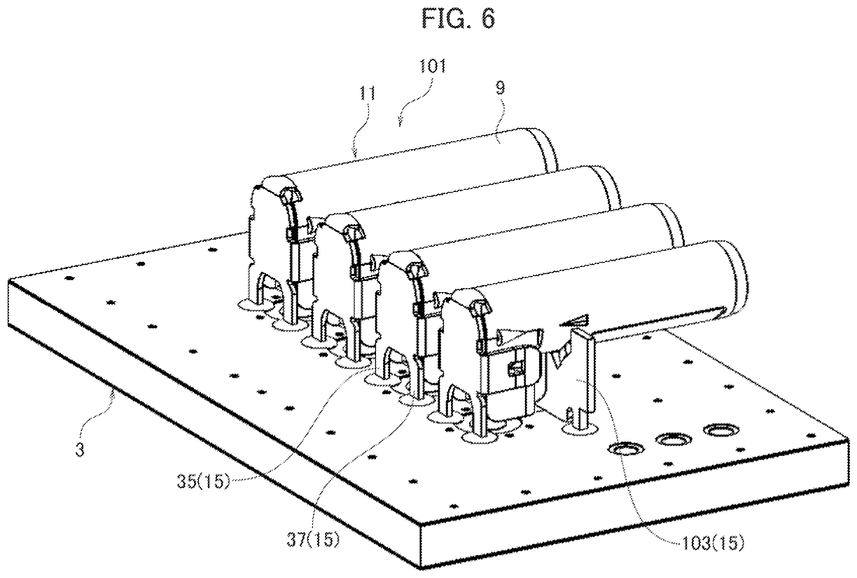

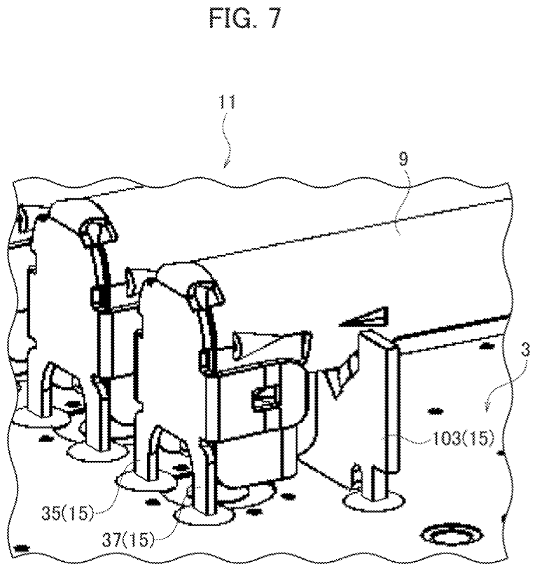

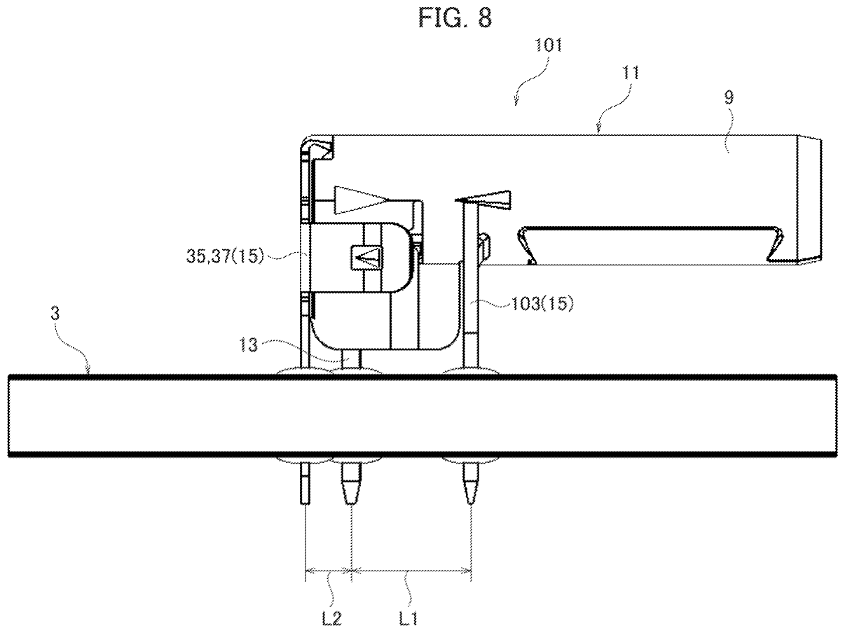

A second embodiment will be described with reference to FIGS. 6 to 8. In FIGS. 6 to 8, the shield member 21 and the outer housing 23 in the first embodiment that may be also included in the second embodiment are omitted in the drawings.

In the circuit board shield connector 101 according to the present embodiment, the cylindrical portion 9 and the first outer connection part 103 are formed as separate bodies.

It should be noted that, in the same configuration as that of the first embodiment, the same symbols are used to refer to the first embodiment and a description of the configuration and the function is omitted. In the same configuration as that of the first embodiment, the effects obtained are the same.

As illustrated in FIGS. 6 to 8, the first outer connection part 103 is formed as a separate body from the cylindrical part 9. The first cuter connection part 103 is fixed to the outer periphery of the cylindrical part 9 at an arbitrary position by, for example, an engaging means engaged with each other or a fixing means such as welding, and is electrically connected to the cylindrical part 9. The first outer connection part 103 is electrically connected to a ground pattern formed on the circuit board 3 by soldering. Thus, the outer terminal 11 is grounded to the circuit board 3.

In the circuit board shield connector 101, since the cylindrical part 9 and the first outer connection part 103 are formed as separately bodies, the first outer connection part 103 can be selectively assembled to the cylindrical part 9 at an arbitrary position. Therefore, the space L1 between the inner connection part 13 and the first outer connection part 103 can be easily adjusted, and the degree of freedom in design can be improved.

Although the present embodiments have been described above, the present embodiments are not limited thereto, and various modifications can be made within the scope of the gist of the present embodiments.

For example, in the embodiments, a plurality of outer connection parts are provided at three locations. However, the plurality of outer connection parts are not limited to this, and two outer connection parts or four or more outer connection parts may be provided.

Further, two or more outer connection parts may be arranged at the front side of the other outer connection parts in the fitting direction of the connection part with respect to the inner connection part.

Further, the outer connection part disposed at the rear side in the fitting direction of the connection part may be formed as a separate body from the cylindrical part.

Further, although the inner connection part and the outer connection part are electrically connected to the circuit board by soldering, the present invention is not limited thereto, and the inner connection part and the outer connection part may be electrically connected to the circuit board by a press fit or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A circuit board shield connector comprising:
an inner terminal having a connection part configured to connect electrically to a circuit board and to connect electrically to a mating terminal by fitting the mating terminal along a planar direction of the circuit board; and
an outer terminal having a cylindrical part, the cylindrical part formed in a cylindrical shape and configured to extend along the planar direction of the circuit board and covering the outer periphery of the connection part while being separated from the connection part and configured to contact with a mating shield member to form a shield circuit, and configured to be grounded to the circuit board, wherein
the inner terminal comprises an inner connection part, the inner connection part extending from the connection part toward the circuit board side and configured to connect electrically to the circuit board,
the outer terminal comprises a plurality of outer connection parts, the plurality of outer connection parts extending from the cylindrical part toward the circuit board side and configured to be grounded to the circuit board,
with respect to the inner connection part, at least one first outer connection part included in the plurality of outer connection parts is on a front side of the other outer connection part of the plurality of outer connection parts in a fitting direction of the connection part,
on the circuit board, a space between the inner connection part and the first outer connection part is set wider than a space between the inner connection part and the other outer connection part.

2. The circuit board shield connector according to claim 1, wherein the cylindrical part, and the first outer connection part are formed as separate bodies.
